(19) United States
(12) Patent Application Publication
(10) Pub. No.: US 2026/0229803 A1
(43) Pub. Date: Aug. 6, 2026

(54) ROBUST, MINIATURIZED FFC CONNECTOR

(71) Applicant: FCI USA LLC, Etters, PA (US)

(72) Inventor: Yasutoshi Kameda, Kisarazu-shi (JP)

(73) Assignee: FCI USA LLC, Etters, PA (US)

(21) Appl. No.: 19/155,186

(22) PCT Filed: Feb. 8, 2024
(86) PCT No.: PCT/US2024/014976

§ 371 Date: Aug. 8, 2025

Related U.S. Application Data
(60) Provisional application No. 63/444,727, filed on Feb. 10, 2023.
(60) Provisional application No. 63/498,805, filed on Apr. 27, 2023.

(51) Int. Cl. H01R 12/77; H01R 12/79

(52) U.S. Cl. CPC H01R 12/774; H01R 12/79

(57) ABSTRACT

A robust, miniaturized electrical connector including a housing and an actuator movable between a latched and an unlatched position to hold or release a flexible circuit. The actuator is biased towards the latched position by a spring arm of a locking terminal. The actuator may be moved from the latched position by insertion of the flexible circuit and will return to that latched position by spring force to autolock. The actuator may have a stable, unlatched state that may be entered by a user pressing on the actuator, but may have an auto-close function. The actuator is held in the housing by the locking terminal, which is soldered to a PCB at two ends of a support arm. Overstress on the spring arm is prevented because the actuator will abut an interior surface of the housing and/or the support arm.

### FIELD OF THE INVENTION

This disclosure relates generally to electrical interconnection systems and more specifically to electrical connectors for mating with flexible circuits.

### BACKGROUND

Electrical connectors are used in many electronic systems. Various electronic devices (e.g., smart phones, tablet computers, desktop computers, notebook computers, digital cameras, and the like) have been provided with assorted types of connectors whose primary purpose is to enable an electronic component to exchange data, commands, or other signals with one or more other electronic components. Signal transmission to transfer information (e.g., data, commands, and/or other electrical signals) often utilizes electrical connectors to complete connections between electronic devices, between components of an electronic device, or between electrical systems that may include multiple electronic devices.

One or more of the connectors may be mounted to a printed circuit board. It is generally easier and more cost effective to manufacture an electrical system as separate electronic assemblies, such as printed circuit boards (“PCBs”), which may be communicatively joined with electrical connectors. In some scenarios, the PCBs to be joined may each have connectors mounted on them. The connectors on two PCBs may be mated directly to interconnect the PCBs.

In other scenarios, the PCBs may be connected indirectly via a cable or different locations on the same PCB may be connected via a cable. Electrical connectors may nonetheless be used to make such connections. For example, the cable may be terminated on one or both ends with a plug type of electrical connector (“plug” herein). A PCB may be equipped with a receptacle type of electrical connector (“receptacle” herein) into which the plug connector may be inserted to connect the cable to the PCB. A similar arrangement may be used at the other end of the cable, to connect the cable to another PCB, so that signals may pass between the PCBs via the cable.

In some cases, a flexible flat cable (FFC), sometimes called a flexible printed circuit (FPC), may be used to route signal between components on different PCB's or on the same PCB. To support such connections, FFC connectors or may be used to connect FFCs to PCBs. The FFC connector may be configured as a receptacle. Rather than receive a plug attached to the FFC, the receptacle may have contacts that mate to conductive pads attached to traces of the FFC, such that an end of the FFC might be inserted into the receptacle.

Some FFC receptacles include a locking mechanisms to lock the FFC in the receptacle, which may prevent the FFC from unintentional disconnection from the connector and may ensure a stable connections between the FFC and the PCB. The locking mechanism may be activated upon insertion of the FFC into the receptacle. The receptacle may include an actuator to release the FFC when desired.

FFCs are sometimes used inside electronic devices in which miniaturization is desirable. For example, an FFC may be used inside a laptop computer to connect two subassemblies. In these scenarios, it may be desirable for the connector that mates with the FFC to also be miniaturized. However, making connectors smaller can make them less robust, as smaller components can be more susceptible to yielding or breaking such that they no longer perform as intended. Accordingly, it is challenging to design an FFC connector that is robust.

### SUMMARY

Techniques as described herein may be embodied as an electrical connector comprising a housing configured to receive a mating component and comprising a mounting face, a plurality of contacts held in the housing and an actuator. The actuator may comprise a latching member configured to engage a mating component inserted into the housing and an outer surface defining a shelf. The actuator may be partially exposed outside of the housing and may be movably coupled to the housing so as to be movable between a latched position and an unlatched position. The connector may also comprise a locking terminal mounted to the housing. The locking terminal may comprise a spring arm configured to press against the shelf when the actuator is moved from the latched position to the unlatched position so as to bias the actuator towards the latched position, and a support arm, wherein the spring arm is between the support arm and the shelf.

Techniques as described herein may be embodied as an electrical connector comprising a housing, an actuator and a locking terminal mounted to the housing. The housing may comprise a slot configured to receive a mating component and a mounting face. The connector may also comprise a plurality of contacts held in the housing, wherein the plurality of contacts comprise tails, configured for mounting to a printed circuit board, exposed at the mounting face. The actuator may comprise a latching member configured to engage a mating component inserted into the housing. The actuator may be partially exposed outside of the housing and may be movably coupled to the housing so as to be movable between a latched position and an unlatched position. The locking terminal may comprise a spring arm configured to press against a portion of the actuator when the actuator is moved from the latched position to the unlatched position so as to bias the actuator towards the latched position, a support arm comprising a first end and a second end, a first member extending from the first end of the support arm to the mounting face and configured for mounting to the printed circuit board, and a second member extending from the second end of the support arm to the mounting face and configured for mounting to the printed circuit board.

Techniques as described herein may also be embodied as a method of operating an electrical connector comprising an actuator comprising a latching member and a locking terminal comprising a spring arm and a support arm. The method may comprise biasing the actuator towards a latched position with the spring arm and moving the actuator towards an unlatched position where a portion of the actuator abuts the support arm of locking terminal.

Any of the electrical connectors as described herein may have a stable state in which the actuator is in an unlatched position such that a mating component may be withdrawn. Optionally, withdrawing the mating component may move the actuator from its unlatched state such that the actuator is urged into a latched position by the biasing force of the locking terminal.

The foregoing features may be used, separately or together in any combination, in any of the embodiments discussed herein.

### BRIEF DESCRIPTION OF DRAWINGS

Various aspects and embodiments of the present technology disclosed herein are described below with reference to the accompanying figures. It should be appreciated that the figures are not necessarily drawn to scale. Items appearing in multiple figures may be indicated by the same reference numeral. For the purposes of clarity, not every component may be labeled in every figure.

FIG. 1 is a perspective view of an interconnection system with a flexible circuit positioned for insertion into an exemplary board connector.

FIG. 2 is a rear, side perspective view of the interconnection system of FIG. 1.

FIG. 3 is an exploded view of the receptacle connector of the interconnection system of FIG. 1.

FIG. 4A is a front, side perspective view from above of a housing of the exemplary board connector of FIG. 1.

FIG. 4B is a rear, side perspective view from above of a housing of the exemplary board connector of FIG. 1.

FIG. 5 is a perspective view of the actuator of the exemplary board connector of FIG. 1.

FIGS. 6A-6C are a front, right side, perspective view from above, a front, left side perspective view from below, and a right, side view of a locking member of the exemplary board connector of FIG. 1.

FIGS. 7A-7D are cross-sectional views through a signal contact of an exemplary board connector, such as the board connector of FIG. 1, during insertion of a flexible circuit at successive steps in the insertion process.

FIGS. 8A-8D are cross-sectional views through a latching member of an exemplary board connector, such as the board connector of FIG. 1, during insertion of a flexible circuit at successive steps in the insertion process.

FIGS. 9A-9D are cross-sectional views through a spring arm of an exemplary board connector, such as the board connector of FIG. 1, during insertion of a flexible circuit at successive steps in the insertion process.

FIGS. 10A-10D are cross-sectional views through a signal contact of an exemplary board connector, such as the board connector of FIG. 1, during removal of a flexible circuit at successive steps in the removal process.

FIGS. 11A-11D are cross-sectional views through a latching member of an exemplary board connector, such as the board connector of FIG. 1, during removal of a flexible circuit at successive steps in the removal process.

FIGS. 12A-12D are cross-sectional views through a spring arm of an exemplary board connector, such as the board connector of FIG. 1, during removal of a flexible circuit at successive steps in the removal process.

FIGS. 13A-13C are cross-sectional views through a spring arm of an exemplary receptacle connector in an embodiment in which the connector is configured to provide a stable latched state, during a process in which a user moves an actuator from a latched position to that stable unlatched position.

FIGS. 13D-13E are cross-sectional views through the spring arm of the exemplary receptacle connector of FIGS. 13A-13C during a process in which the user moves the actuator from the stable unlatched position to the latched position.

FIGS. 14A-14D are cross-sectional views through a latching member of an alternative exemplary board connector that has a stable unlatched position and is configured to return to a latched position by removal of a flexible circuit from the connector while the connector is in the stable unlatched state.

FIG. 15 is a front, left side, perspective view from below of a locking member of the exemplary board connector of FIG. 1.

FIGS. 16A-16D are cross-sectional views through a spring arm of an exemplary board connector, such as the board connector of FIG. 1, having the locking member of FIG. 15 during insertion of a flexible circuit at successive steps in the insertion process

### DETAILED DESCRIPTION

The inventors have recognized and appreciated design techniques that enable a connector to be simply constructed while providing simple operation and robust performance over its lifetime, even when miniaturized. These techniques may be applied to a receptacle connector that includes an actuator to release latching members that hold a mating component, such as an FFC, in the connector. The actuator may be movably held in a receptacle housing with a locking terminal that enables simple construction techniques, but retains the actuator in position to latch and release the mating component inserted into the connector and is resistant to damage due to overstress.

One or more features optionally may be included in the connector to simplify operation of the connector. The connector alternatively or additionally may provide autolocking, such that a mating component inserted into the connector is locked in place without a user manipulating the actuator. Additionally or alternatively, the actuator may have a stable unlatched position such that, once the user moves the actuator to this stable position, the actuator stays in that position until a force moves it towards a latched position. With this feature, a user may separately unlatch the inserted component and remove it, which provides for simple operation of the connector in comparison to, for example, a design that requires the user to hold the actuator in the unlatched position while the mating component is removed.

In some scenarios, the force to move the actuator from the stable unlatched position towards the latched position may be supplied by the user. A user, for example, may press on the actuator to return the actuator to the latched position. Optionally, a connector with a stable unlatched position may be configured to return to a latched position automatically based on withdrawal of the mating component. In that example, the actuator may include a feature that is engaged by the mating component as it is removed, providing sufficient force on the actuator to move it out of its stable, unlatched position. Once out of the stable position, biasing force provided by the locking terminal may urge the actuator back into the latched position.

Such a connector may be implemented with an actuator that has portions captured within cavities of a housing of the receptacle connector. The actuator may be biased into a latched position in which the latching members extend through a flat flexible circuit, latching a flat flexible circuit inserted in the connector in a position that contacts within the connector mate with pads on the flat flexible circuit. The flat flexible circuit may be released by moving the actuator from the latched position to an unlatched position, which withdraws the latching members from the flat flexible circuit such that the flat flexible circuit may be removed from the connector.

The actuator may be held in the housing with locking terminals that have a spring arm and a support arm. Each locking terminal may be formed as an integral structure, such as from a sheet of metal.

The spring arm may bias the actuator into the latched position. The spring force on the actuator may be such that it can be overcome by insertion of the flat flexible circuit into the connector or by a user moving the actuator. In the latched position, for example, the latching member may block the path of the flat flexible circuit into the connector such that an edge of the flat flexible circuit presses against the latching members, forcing the actuator to move into an unlatched position.

Alternatively or additionally, the actuator may include a beam, at least an edge of which is exposed outside the connector housing. The exposed portion of the actuator may provide a mechanism for a user to move the actuator into the unlatched position such that the flat flexible circuit may be removed from the connector. In some examples, an unlatched position may be a stable state for the actuator such that, once moved to this position, the actuator may stay in an unlatched position. The actuator may remain in the unlatched position until pushed by the user.

The support arm may hold the actuator in the connector housing and/or ensure that the spring arm stays in position to provide a biasing force on the actuator. Robustness of the connector may be enhanced by firmly coupling the support arm to a substrate. The support arm, for example, may be coupled at two ends to a substrate, such as a printed circuit board (PCB) to which the connector is mounted. For example, members extending from ends of the support arm may extend towards the mounting interface of the connector where they can be soldered to the PCB. The support arm may block a portion of the actuator from being withdrawn from an opening in the connector housing, while still allowing the actuator to move relative to the connector housing.

Alternatively or additionally, the support arm may be positioned to reduce overstress of the spring arm. The spring arm, for example, may be aligned with the support arm such that, upon motion of the actuator from the latched to unlatched position, excessive motion of the spring arm is blocked by the support arm. Alternatively or additionally, the support arm may reduce overstress on the spring arm by limiting motion of the actuator past an unlatched position. A portion of the actuator, for example, may be aligned with the support arm such that, when the actuator moves towards the unlatched position, that portion of the actuator approaches the support arm such that the support arm will interfere with that portion of the actuator if the actuator is urged past the unlatched position. Alternatively or additionally, the support arm may reduce overstress on the spring arm by limiting deflection of the spring arm past its position in an unlatched state. Limiting deflection can prevent the sprig arm from yielding, which would degrade performance of the connector.

The inventors have further recognized and appreciated that, due to the compact size of some receptacle connectors, it may be easy for a user to unintentionally overstress elements of the connector. Moreover, the small structure of the connector may not provide sufficient resistance to this force to avoid damage. That is, it may be physically easy for a user to accidentally apply force that causes damage. Connector features as described herein may reduce or eliminate the possibility of damage to a receptacle connector, including both when the actuator is moved by the user during an unmating operation or if force is applied to the actuator at other times, such as if the actuator is accidently pulled.

Accordingly, one or more of the techniques described herein may be applied to a connector to provide a robust, miniaturized electrical connector for mating to a flexible circuit. The electrical connector may include a housing and an actuator mounted in the housing so as to move between a latched position and an unlatched position to hold the flexible circuit in the housing or release the flexible circuit from the housing. The actuator may be biased into the latched position by force of a spring arm of a locking terminal pressing against a shelf on an exterior portion of the actuator. The actuator may be moved from the latched position by insertion of the flexible circuit or activation by a user. The actuator is held in the housing by the locking terminal, which is shaped for soldering to a PCB to which the connector is mounted in two locations at two ends of a support arm, with a hub or other portion of the actuator captured between the support arm and the housing. Overstress on the spring arm is prevented by limiting motion of the actuator past an unlatched position by a surface of the actuator abutting an interior surface of the housing and/or the support arm.

Illustrative examples of some of the above-described electrical connectors are illustrated in the figures, described below.

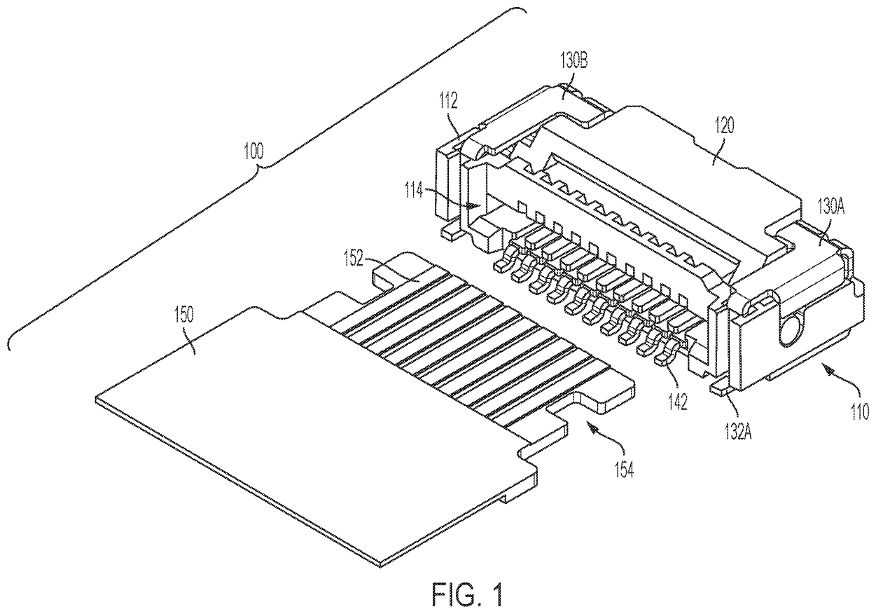

FIG. 1 is a perspective view of an interconnection system 100 with a connector 110, here configured as a board mounted receptacle, and a cable providing a flexible circuit element. In this example, the cable is flat and may be implemented as a flexible printed circuit (FPC) or a flexible flat cable (FFC), and, regardless of implementation is exemplified by flat flexible circuit 150. In this example, flat flexible circuit 150 has pads 152 that are terminals for conductive traces within flat flexible circuit 150. As pictured, pads 152 are positioned in an array along a forward edge of flat flexible circuit 150.

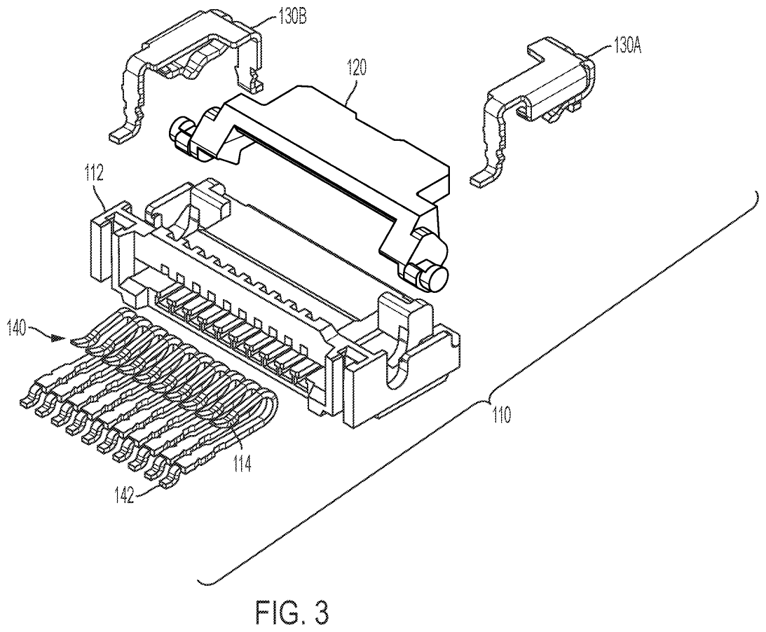

Connector 110 includes a housing 112, which may be molded of insulative material such as plastic or nylon. Housing 112 may be shaped to provide a mating interface and a mounting interface. The mating interface is within slot 114 into which the forward edge of flat flexible circuit 150 may be inserted to mate flat flexible circuit 150 to connector 110. Contacts 140 (FIG. 3) are inserted into slot 114 with contact surfaces 144 (FIG. 3) exposed in the slot to define a mating interface for connector 110. When the forward edge of flat flexible circuit 150 is inserted a sufficient into slot 114, contact surfaces 144 contact pads 152, making electrical connections between the traces of flat flexible circuit 150 and contacts 140.

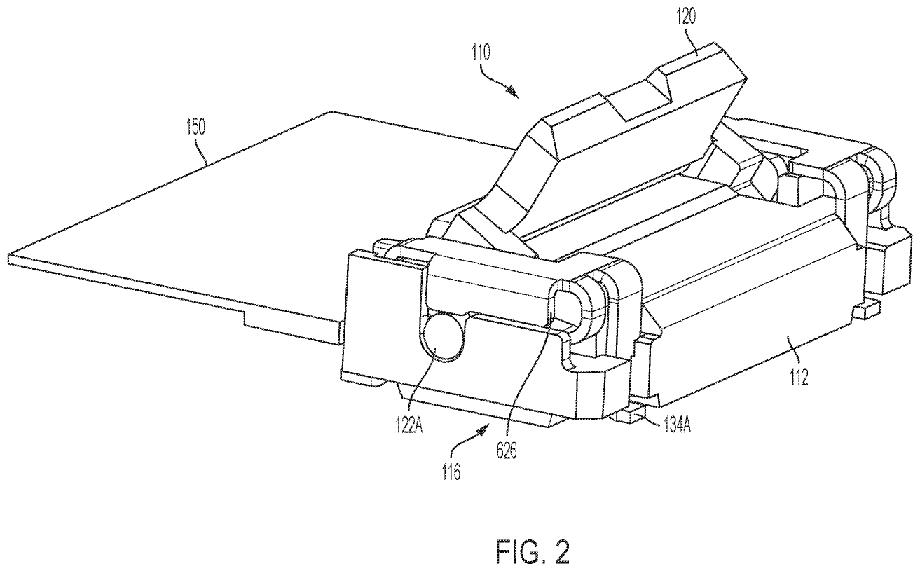

Tails 142 of contacts 140 extend from housing 112 at the mounting interface 116 (FIG. 2). In this example, connector 110 is configured for mounting to a printed circuit board (PCB) and mounting interface 116 is generally planar and on a lower surface of housing 112. Tails 142 are shaped for electrical and mechanical attachment to a PCB. In this example, tails 142 are shaped for surface mount soldering to pads on a PCB. Regardless of attachment technology used for mounting connector 110 to a PCB or other substrate, mating flat flexible circuit 150 to connector 110 makes electrical connections through connector 110 between portions of an electronic system coupled to the remote end of flat flexible cable 150 and other portions of the electronic system coupled to the PCB to which connector 110 is mounted.

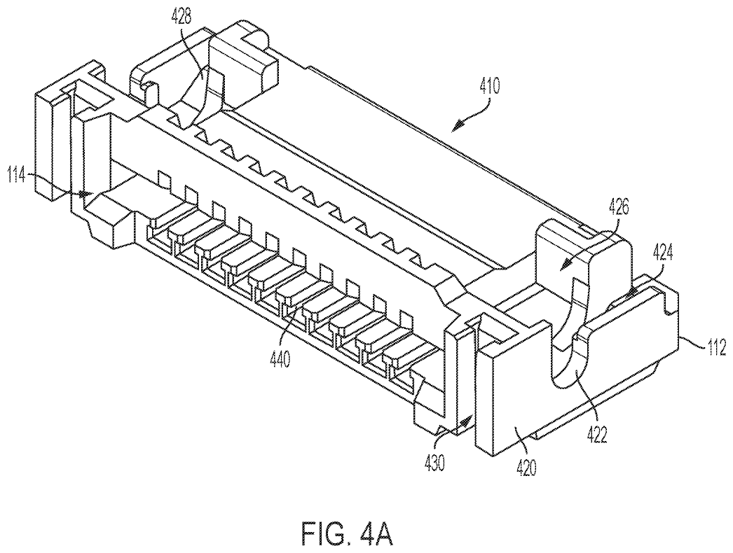

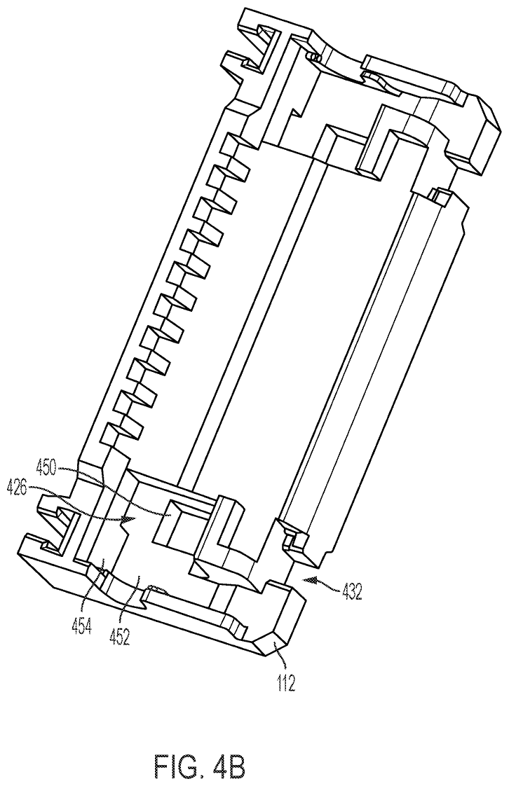

To ensure reliable connections between these components, flat flexible circuit 150 may be latched within the mating interface of connector 110. For this purpose, connector 110 may including latching members (not visible in FIG. 1) that may pass through or otherwise engage flat flexible circuit 150 when inserted to a designed location within connector 110. When latching members engage flat flexible circuit 150, withdrawal of flat flexible circuit 150 is blocked. To withdraw flat flexible circuit 150, actuator 120 may be moved by a user from a latch state, as shown in FIG. 1, to an unlatched state, as shown in FIG. 2. Moving actuator 120 with respect to housing 112 disengages the latching members from flat flexible circuit 150, such that flat flexible circuit 150 may be withdrawn from connector 110. In this example, actuator 120 is molded of plastic or other insulator. In other examples, however, actuator 120 May be die cast or otherwise formed of metal and may serve a shielding function. Actuator 120 may be movably mounted in housing 112 such that it may move from the latched state of FIG. 1 to the unlatched state of FIG. 2. In the example of FIG. 1, movable mounting may be provided, at least in part, by hubs 122 projecting into an opening in a wall (e.g. end wall 420, FIG. 4) of housing 112 that acts as a bearing surface. In some examples, movement of actuator 120 may be rotation about hub 122.

FIG. 1 is a right side view of connector 110 in which the left side of connector is not visible. In the example illustrated, the right side and the left side of connector 110 include the same features and are symmetrical. Accordingly, for simplicity of illustration, the right side of connector 110 is predominately shown and described, but the disclosure with respect to the right side of connector 110 may apply to the left side, and vice versa.

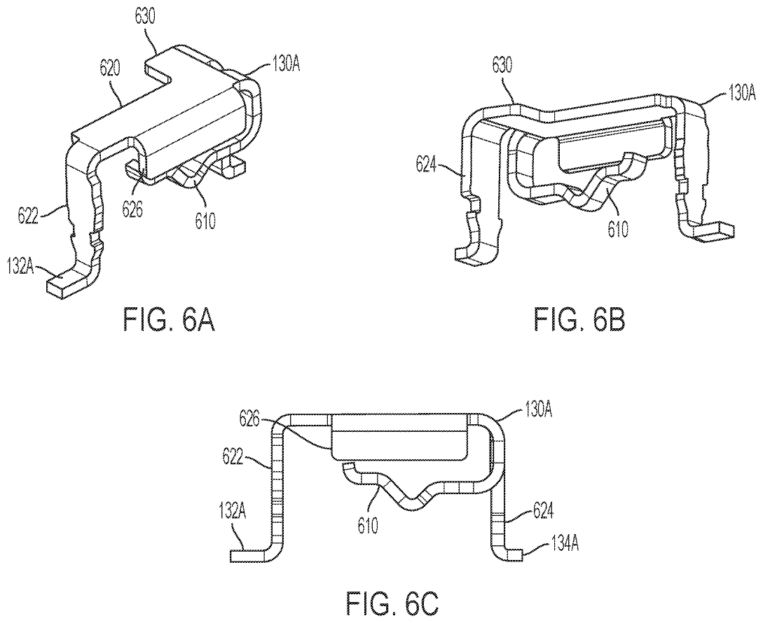

Actuator 120 may be held within housing 112 by one or more locking terminals, of which locking terminals 130A and 130B are shown. In this example, locking terminal 130A includes a tab 626 (FIG. 6) that captures hub 122 and a surface of housing 112 that acts as a bearing surface.

In this example, each of the locking terminals 130A and 130B is formed from a sheet of metal that is stamped and then formed to have the shape shown. The metal may be springy, such as stainless steel or spring steel such that a portion of each of the locking terminals may be configured to bias actuator 120 into the latched position illustrated in FIG. 1. If a user moves the actuator to the unlatched state shown in FIG. 2, once the actuator is released, actuator 120 may return to the latched state shown in FIG. 1, in some embodiments.

FIG. 3 is an exploded view of connector 110.

FIGS. 4A and 4B are side perspective views from above of housing 112, with FIG. 4A being from the front and FIG. 4B being from the rear. FIG. 4A shows that a floor of slot 114 is lined with grooves 440. A contact 140 may fit within each groove 440. Contacts 401 may be inserted into grooves 440 to hold contacts 140 in position to mate with pads 150 on flat flexible circuit 150 when inserted in slot 114.

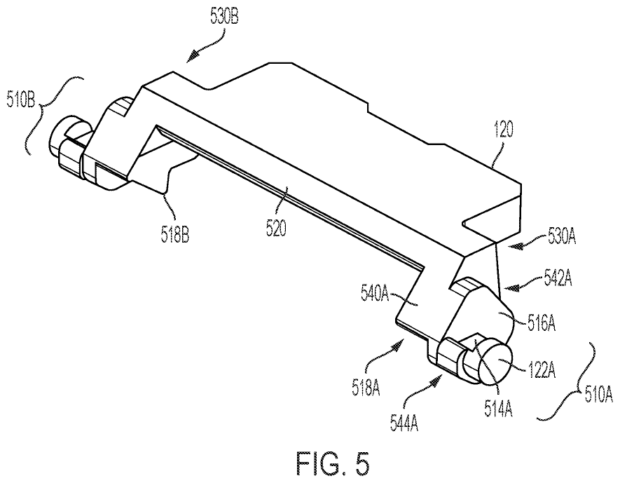

In these views, a recessed area 410 is visible. A portion of actuator 120 may fit within recessed area 410 when in the latched state. In the illustrated configuration, beam 520 (FIG. 5) of actuator 120 may fit within area 410. In the state shown in FIG. 1, at least an edge of beam 520 (FIG. 5) may be exposed outside of housing 112. A rear edge of beam 520, for example, may be exposed and a user may use a finger or tool to press against the rear edge of beam 520 to move actuator 120 from the latched position to an unlatched position.

Actuator 120 may include arms 530A and 530B (FIG. 5) extending from the beam in a direction transverse to the elongated dimension of beam 520. In this example, arms 530A and 530B extend in parallel from beam 520 and are perpendicular to the elongated dimension of beam 520.

Housing 112 may be shaped to receive arms 530A and 530B. Housing 1112 may include a cavity, for example, to receive each arm. Cavity 426 (FIGS. 4A and 4B), for example, may receive at least a portion of arm 530A. A cavity (not numbered) may similarly be located at the opposite end of housing 112, as can be seen in FIG. 4B to receive arm 530B.

At least a portion of cavity 426 may communicate with slot 114 such that a latching member coupled to actuator 120 may engage flat flexible circuit 150 inserted in slot 114. In the example of FIG. 4B, cavity 426 has a floor 452 separating it from slot 114. Floor 452 has an opening 450 providing access between cavity 426 and slot 114. Latch 518A (FIG. 5) may be aligned with opening 450. When actuator 120 is engaged in housing 112 and moved into a latched state, latch 518A may extend through opening 450 into slot 114. When flat flexible circuit is inserted into slot 114 into a designed mating position, notch 154 may also align with opening 450 such that latch 518A may extend into notch 154. In this way, moving actuator 120 into a latched position may latch flat flexible circuit 150 in connector 110.

Latch 518A is not visible in the view of FIG. 5, but latch 518B is. In the example illustrated, actuator 120 is symmetrical about the center of actuator 120 in the elongated direction. Accordingly, end portions 510A and 510B include the same components. As can be seen in FIG. 5, latch 518B extends from a distal end of arm 530B in the elongated direction of arm 530B. Latch 518A similarly extends from arm 530A.

Housing 112 may also have features to facilitate movably mounting actuator 120 in housing 112. In the illustrated example, locking terminals 130A and 130B hold actuator 120 in housing 112. Housing 112 includes features for positioning the locking terminals. A groove 430, for example, may receive a member 622 (FIG. 6A) of locking terminal 130A. In the example of FIG. 6A, a distal end of member 622 may include a tail configured for attachment to a PCB to which connector 110 is mounted. In this example, tail 132A is shaped as a foot configured for surface mount soldering. Either or both of member 622 and groove 430 may include features to retain member 622 within groove 430 until tail 132A is attached to a PCB. In this example, member 622 includes barbs that engage sides of groove 460.

Locking terminal 130A may be attached to a PCB in multiple locations. In the example illustrated, locking terminal 130A has two members, 622 and 624 (FIGS. 6A-6C), each of which extends to the mounting interface 116 where they are terminated in a tail configured for mounting to a PCB. In the illustrated example, member 624 terminates in tail 134A. Member 624 may be inserted into groove 432, for example.

Though not numbered for simplicity, grooves shaped similarly to grooves 430 and 432 may be included at the opposite end of housing 112 to receive corresponding portions of locking terminal 130B.

Housing 112 may be shaped such that, when actuator 120 is inserted into the housing and then locking terminals 130A and 130B are inserted, actuator 120 may be movably held within housing 112. Locking terminal 130A, for example, includes a tab 626 (FIGS. 6A-6C), which serves this purpose. When members 622 and 624 of locking terminal 130A are inserted into housing 112, tab 626 may engage a portion of actuator 120 to prevent actuator 120 from being removed from housing 112.

In the illustrated example, a portion of actuator 120 is captured between a portion of housing 112 and a portion of locking terminal 130A. In the example of FIG. 4A, end wall 420 of housing 112 includes a notch 422, which has a rounded profile at a bottom edge. Hub 122A of actuator may extend into and/or through notch 422 such that the bottom edge of notch 422 may act as a bearing surface for hub 122A, enabling actuator 120 to rotate about hub 122A. Tab 626 may be positioned to capture hub 122A in notch 422 such as is shown in FIG. 2. Tab 626 may loosely hold hub 122 in notch 422 such that hub 122A can rotate within notch 422.

Alternatively or additionally, other portions of locking terminal 130A may block withdrawal of other portions of actuator 120 from housing 112. In the illustrated example, locking terminal 130A has a support arm 620 (FIGS. 6A-6C). When locking terminal 130A is inserted in housing 112, support arm 620 may span an opening of cavity 424. When portions of actuator 120 projecting from arm 530A are inserted into cavity 424, support arm 620 may interfere with those projecting portions, blocking withdrawal of those portions from cavity 424.

One or more locking terminals may alternatively or additionally include features that bias actuator 120. FIG. 1, for example, may be an illustration of the rest state of the connector in which the actuator is in a latched position. Instead of or in addition to providing retention, locking terminals 130A and 130B may provide a biasing force on actuator 120. That biasing force may bias actuator 120 into one of the states, which is a latched state in this example. Biasing force may be provided by spring arm 610 (FIGS. 6A-6C) of locking terminal 130A.

Spring arm 610 may be aligned with an exterior surface of end portion 510A such that, when actuator 120 rotates from a latched to an unlatched position, that exterior surface presses against and deflects spring arm 610, generating a force that urges actuator back towards the latched state. In the example of FIG. 5, end portion 510A of actuator 120 includes a shelf 514A and spring arm 610 of locking terminal 130A presses against shelf 514A.

FIG. 5 illustrates further details of an example implementation of actuator 120. In this view, beam 520 is visible, with arms 530A and 530B extending from opposing ends. Each of the arms has an end portion 510A and 510B that projects from a distal end of the arm. These end portions project in a direction parallel to an elongated dimension of beam 520.

In this example, hub 122A is at a distal end of the projecting portion. Shelf 514A is formed on an exterior surface of a portion adjacent hub 122A. Rocker 516A is next to shelf 514A, which is the part of the projecting portion closest to arm 530A.

Rocker 516A has an arcuate surface 544A, which in this example faces downwards. When actuator 120 is inserted into housing 112, arcuate surface 544A faces floor 452. Arcuate surface 544A may be held away from floor 452 based on mounting of actuator 120 via hub 122A in notch 422. In such a scenario, arcuate surface 544A may be shaped to provide separation between end portion 510A and floor 452 regardless of the orientation of actuator 120. Alternatively or additionally, actuator 120 may be mounted in housing 112 with a segment of arcuate surface 544A in contact with floor 452. In such a scenario, arcuate surface 544A may enable actuator 120 to move with a rocking motion. That rocking motion may result from successive segments of arcuate surface 544A contacting floor 452.

In the example of FIG. 5, the lower surface of shelf 514A is shaped so as not to interfere with motion of the actuator 120 from a latched to an unlatched position, and vice versa. In this example, shelf 514A also has an arcuate surface facing floor 452, which may have a surface profile conforming with arcuate surface 544A of rocker 516A.

Latch 518A is position such that it could contact a floor 452. However, the portion of floor 452 aligned with latch 514A has an opening 450, which prevents latch 518A from blocking actuator 120 from moving from a latched to an unlatched position within housing 112.

In the example of FIG. 5, portions of actuator 120 may be shaped to abut other portions of connector 110 to restrict motion of actuator 120 beyond an unlatched position. These other portions of connector may be portions of housing 112, potions of locking terminals 130A and 130B and/or other portions of connector 110. In the example illustrated, surfaces 540A and 542A are limiting surfaces that may abut other portions of connection 110 when actuator is moved beyond a designed unlatched position. Surfaces 540A, for example, may abut an interior side wall 454 (FIG. 4). Surface 542A, for example, may abut support arm 620.

Arms 530A and 530B, and the projections extending from them, are symmetrical about the centerline of beam 520, such that the description of arm 530A, and the portion projecting from arm 530A, applies equally to arm 530B and end portion 510B projecting from arm 530B.

FIGS. 6A-6C illustrate locking terminal 130A. In this example, locking terminal 130A is stamped from a sheet of metal such that the illustrated portions of locking terminal 130A are integral with one another.

In this example, spring arm 610 is aligned with support arm 620. With such a configuration, deflection of spring arm 610 may be limited by support arm 620, which may prevent spring arm 610 from being overstressed. Overstress on a spring arm may cause the spring arm to yield such that it does not return to its undeflected state, which can interfere with intended operation of the connector.

To support stamping from a sheet of metal, support arm 620 includes a wing 630 from which 624 extends. Nonetheless, in cross section, such as is illustrated in FIG. 6C, support arm and members 622 and 624 combine to form a generally U-shaped structure. When locking terminal 130A is inserted into housing 112 after actuator 120 is inserted in the housing, a portion of actuator 120 is captured within this open area of the U. When the ends of members 622 and 624 are affixed to a PCB, that U-shaped structure is robust, providing secure retention of actuator 120.

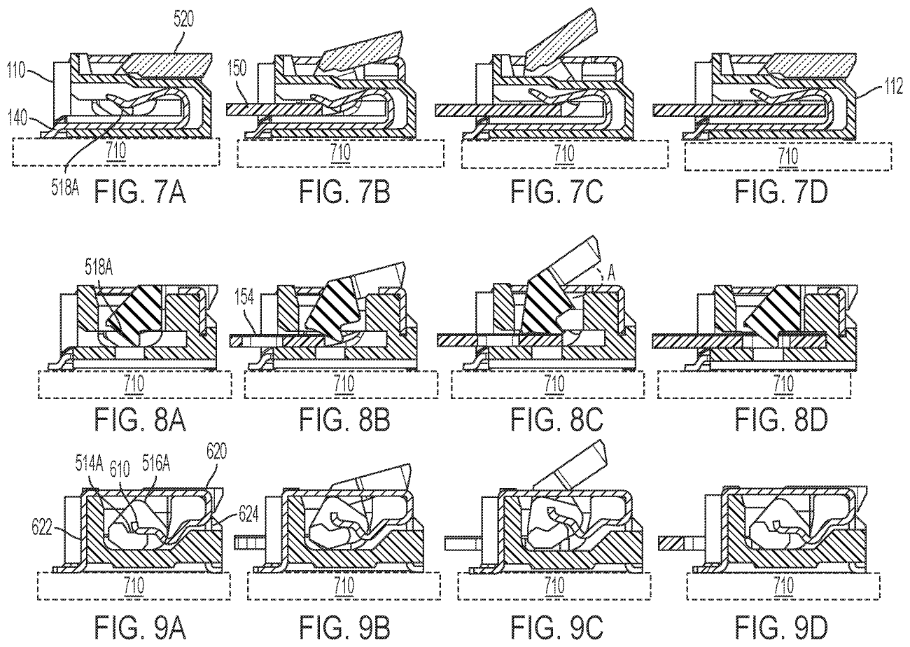

FIGS. 7A to 9D illustrate operation of a connector, such as connector 110, during insertion of a flat flexible circuit 150. FIGS. 7A-7D are cross sections through a contact 140 at successive steps during insertion of flat flexible circuit 150. FIG. 7A illustrates a connector 110 mounted to a PCB 710, such as via surface mount soldering, without flat flexible circuit 150 present. In this state, actuator 120 is in a latched state, with latch 518A in the path over which a flat flexible circuit 150 is inserted into slot 114.

FIG. 7B illustrates a step in the operation at which flat flexible circuit 150 has been inserted into slot 114 to the point that a leading edge of flat flexible circuit 150 is approaching a contact surface 144. In this state, the leading edge of flat flexible circuit 150 has contacted latch 518A and pushed it, such that actuator has moved, as can be seen from the change in angle of beam 520 relative to PCB 710. The movement may be, for example, rotation around hub 122A and/or rocking of an arcuate surface 544.

FIG. 7C illustrates a successive step in which flat flexible circuit 150 has been inserted further, such that latch 518A is sliding along an upper surface of flat flexible circuit 150. In this state, actuator 120 is in an unlatched state, as latch 518A is no longer blocking slot 114.

FIG. 7D illustrates a further step in which flat flexible circuit 150 has been inserted further, such that notch 154 is aligned with latch 518A. In this state, with force on latch 518A as a result of contact with flat flexible circuit 150 removed, actuator 120 returns to the latched state. In this state, latch 518A extends into notch 154. If an attempt is made to remove flat flexible circuit 150 while connector 110 is in this state, a rearward edge of latch 518A catches on an edge of notch 154, blocking removal of flat flexible circuit 150.

FIGS. 8A-8D illustrate the same steps in the insertion operation of FIGS. 7A-7D. FIGS. 8A-8D illustrate connector 110 in cross section through latch 518A. In these figures, movement of actuator 120 from a latched to an unlatched state as a result of contact between a leading edge of flat flexible circuit 150 and a forward edge of latch 518A can be seen.

In the example, of FIG. 8D, latching of flat flexible circuit 150 as a result of engagement between a rearward edge of latch 518A and an edge of notch 154 can also be seen. In this state, actuator 120 does not move in response to the force of pulling flat flexible circuit 150 transferred to actuator 120 where flat flexible circuit 150 contacts latch 518A. Further rotation of actuator is blocked by interference between one or more components of actuator 120 and housing 112. For example, beam 520 may be inside recessed area 410 such that it contacts as surface of housing 112, as shown for example, in FIG. 7D.

FIGS. 9A-9D illustrate the same steps in the insertion operation of FIGS. 7A-7D. FIGS. 9A-9D illustrate connector 110 in cross section through shelf 514A. In these figures, deflection of spring arm 610 as a result of motion of shelf 514A can be seen. Likewise, return of the shelf 514A to its position in the latched state as a result of spring force generated by deflection of spring arm 610 can also be seen. The U-shaped structure formed by support arm 620 and members 622 and 624 is also visible.

FIGS. 10A to 12D illustrate operation of a connector, such as connector 110, during removal of a flat flexible circuit 150. FIGS. 10A-10D are cross sections through a contact 140 at successive steps during removal of flat flexible circuit 150. FIG. 10A illustrate a latched state and may, for example, correspond to the state illustrated in FIG. 7D.

FIG. 10B illustrates that a user may actuate actuator 120 to move it to an unlocked state. In this example, a user has pressed on the rearward edge of beam 520 to move actuator 120. Motion, for example, may be rotation about hub 122A and/or rocking along an arcuate surface 544. Regardless of the mechanism by which actuator 120 moves, that motion may remove latch 518A from notch 154.

FIG. 10C illustrates that, with latch 518A removed from notch 154, flat flexible circuit 150 may be removed from slot 114, such as by pulling on flat flexible circuit 150.

FIG. 10D illustrates that, once the user releases beam 520 and flat flexible circuit 150 has been removed, actuator 120 may return to its latched state, as sown in FIG. 10D.

FIGS. 11A-11D illustrate the same steps in the insertion operation of FIGS. 10A-10D. FIGS. 11A-11D illustrate connector 110 in cross section through latch 518A.

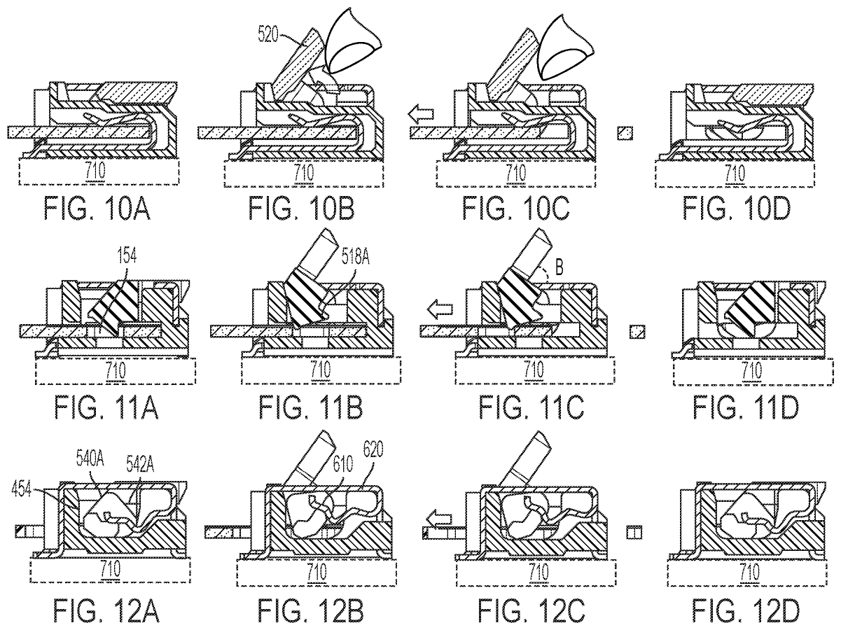

FIGS. 12A-12D illustrate the same steps in the insertion operation of FIGS. 10A-10D. FIGS. 12A-12D illustrate connector 110 in cross section through shelf 514A. In this view, it can be seen that spring arm 610 is between the support arm 620 and the shelf 514A. Portions of rocker 516A, including surfaces 540A and 542A, are visible in these cross sections. These figures illustrate that interference between actuator and 120 can limit the amount of movement of actuator 120, which in turn limits the amount of deflection of spring arm 610, which can prevent spring arm 610 from being overstressed. It can also be seen that deflection of spring arm could alternatively or additionally be limited by support arm 620 by positioning support arm 620 such that spring arm 610 abuts support arm 620 when spring arm 610 is deflected past its position in an unlatched state.

FIG. 12B, for example, illustrates that rotation of beam 520 has been limited to a predetermined angle. In this example, that limitation is established by surface 540A abutting interior side wall 454. Alternatively or additionally, that limitation may be established by surface 542A abutting support arm 620. Limiting overstress on spring arm 610 enables a robust connector, that may be simply constructed.

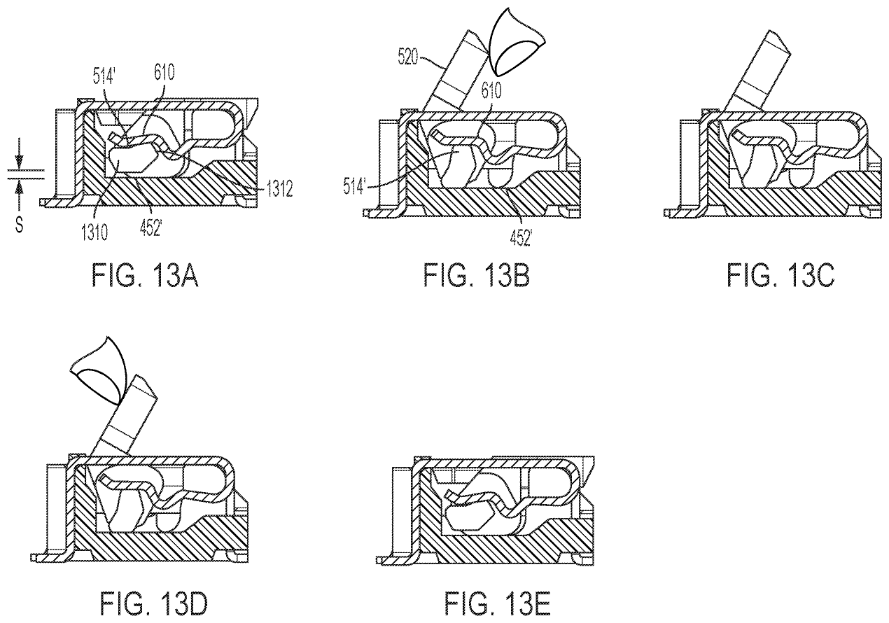

FIGS. 13A-13D illustrates operation of an embodiment of a connector, such as connector 110, that has a stable unlatched state. As in FIGS. 9A-9D and 12A-12D, FIGS. 13A-13D illustrate cross-sections through a spring arm 610. In this example, FIG. 13A do not show flat flexible circuit 150, but latching may be performed as in the examples of FIGS. 9A-9D and 12A-12D, FIGS. 13A-13D. For simplicity of illustration, a PCB is not shown, but a connector as shown in FIGS. 13A-13D may be mounted to a PCB or other substrate.

In this example, an actuator may be shaped generally as shown in FIG. 5 with a beam 520, arms 530A and 530B at each end of the beam and a projection at each end portion 510A and 510B of the arms. Each projection may include a hub, such as hub 122A, and a portion with a shelf, such as shelf 514A. However, in the embodiment of FIGS. 13A-13D, the portion with shelf 514′ is shaped to provide a separation S between that portion of the actuator and the floor 452′ of the cavity of the connector housing receiving the projection from the arm of the actuator. this separation S is shown in FIG. 13A when the actuator is in a latched state. That portion including shelf 514′, for example, may be supported by hub 122A rather than by contact with a housing. With a separation S, an arcuate surface on the projection may be omitted without interfering with rotation of the actuator.

Shelf 514′, as with shelf 514 described above, is a flat surface aligned with spring arm 610. Rotation of the actuator out of the latched position towards the unlatched position presses shelf 514′ against a distal end of spring arm 610, which deflects the spring arm. Deflection of spring arm 610 generates a counter force, biasing shelf 514′ and the actuator in general, towards the latched position. As above, rotation of the actuator may be based on insertion of a flat flexible circuit 150 into the connector or a user pressing on the actuator.

The connector may be configured such that the biasing force has a different effect, depending on how the actuator is moved. The connector may be configured with a stable state for the actuator in which the bias force does not return the actuator to the latched position. For example, the portion of the projection from the actuator arm, or some other portion of the actuator, may be shaped such that, when the actuator is rotated more than a threshold amount, the biasing force generates insufficient moment around the axis of rotation of actuator 120 to overcome other forces restraining rotation of the actuator. Omitting the arcuate surfaces on the portion of the actuator including shelf 514′ may enable that portion to be shaped to create a stable unlatched state.

Such a configuration may be exploited to provide an autolock connector that supports easy removal of the flat flexible circuit from the connector. For example, insertion of the flat flexible circuit into the connector may rotate the actuator sufficiently for a latching member to clear a path for insertion of the flat flexible circuit, but less than the threshold amount. As a result, a user may simply insert the flat flexible circuit into the connector and does not have to manually move the actuator to either create clearance for insertion of the flat flexible circuit or to latch the flat flexible circuit in the connector after it is inserted to the designed depth. Rather, the retained stress from deflection of spring arm 610 provides sufficient moment to latch the flat flexible circuit into the connector, such as was described in connection with FIG. 8D, above.

In other instances, a user may move the actuator such that it rotates more than the threshold amount. In that scenario, the connector may enter its stable, unlatched state. In that state, the flat flexible circuit may be withdrawn, even if the user releases the actuator. Such an operating state avoids the need for a user to be actively restraining the actuator from returning to the latched state while withdrawing the flat flexible circuit, freeing up a user's hand to hold other parts of the electronic device incorporating the connector or otherwise requiring less user dexterity to remove the flat flexible circuit.

The threshold amount of rotation may be greater than the amount of rotation that occurs upon insertion of a flat flexible circuit, as shown for example by the angle A in FIG. 8C. That threshold amount of rotation may be less than the amount of rotation that occurs when the actuator is rotated to the state in which surfaces of the actuator but against surfaces of the connector housing and/or support arm 620 to restrict overstressing of spring arm 610, such as is shown for example by the angle B in FIG. 11C.

The angle B, for example, may be, in some examples, about 10 degrees greater than angle A. In some examples, the angle B may be in the range of 5 to 25 degrees greater than angle A. Angle B, for example, may be in the range of greater than 55 up to about 75 degrees, such as 61 degrees, for example. Angle A may be in the range of less than 55 degrees down to about 30 degrees, such as about 50 to 52 degrees, for example.

The threshold angle of actuator beam 520 may define a predetermined position into which the actuator position may be moved to place the actuator in a stable, unlatched position. A connector as otherwise described herein may be implemented to provide such a stable state by shaping one or more surfaces of the actuator and/or surfaces of the housing and/or support arm with which those surfaces of the actuator interact. In the example of FIGS. 13A-13D the portion of the actuator including shelf 514′ has additional flat surfaces 1310 and 1312. Flat surfaces 1310 and 1312 are generally parallel to each other and are transverse to the flat surface of shelf 514′. These surfaces are oriented such that, when the actuator is rotated into the predetermined position, the surfaces are parallel to and abut other structures of the connector.

FIG. 13B illustrates a user pressing on beam 520 to move the actuator into the predetermined position. In the state illustrated in FIG. 13B, surface 1310 is aligned with and abuts floor 452′. Surface 1312 is aligned with and abuts a flat portion of spring arm 610. In this configuration, the moment about hub 122A applied to the actuator as a result of retained stress in spring arm 610 is smaller than the moment required to change the orientation of surfaces 1310 and 1312.

The state achieved by placing the actuator in the predetermined position as illustrated in FIG. 13B is retained when the user stops pressing on beam 520. Accordingly, beam 520 retains its position, even when the user stops pressing on the beam 520, as is shown in FIG. 13C. In this state, a user may easily remove or insert a flat flexible circuit. A user may use one hand for that operation, leaving another hand free for other tasks.

To return the actuator to a latched state, a user may press on beam 520, as shown in FIG. 13D. FIG. 13D shows a force being applied to move the actuator in an opposite direction relative to the force applied in FIG. 13B. The force applied by the user may be sufficient to overcome the resistance to rotation generated by surface 1310 abutting floor 452′ and/or surface 1312 abutting a flat portion of spring arm 610. Once this resistance is overcome, the force applied by spring arm 610 may be sufficient to return the actuator to the latched state, as shown in FIG. 13E.

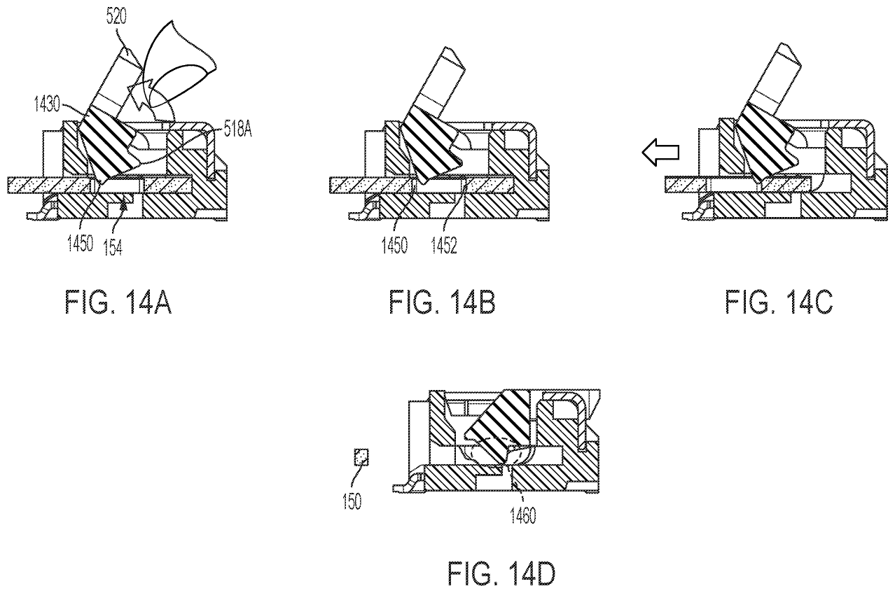

FIGS. 14A-14D illustrate an auto-close function that optionally may be integrated into a connector with a stable, unlatched state, including any of the connectors described herein. FIGS. 14A-14D are cross sections through an arm 1430 of an actuator. In this example, arm 1430 is a right side arm, but similar functionality alternatively or additionally may be implemented in an arm positioned elsewhere in the connector, including a left side arm (not visible in FIGS. 14A-14D).

FIGS. 14A-14D illustrate a latching region 1460 of the connector, which is within a slot 114 of the connector that receives a flat flexible circuit 150. When flat flexible circuit 150 is inserted for mating, notch 154 is within the latching region 1460. When actuator 1430 is rotated into a latched position, latch 518A extends into latching region 1460 such that it passes through notch 154. As described above, such as in connection with FIG. 8D, when the actuator is in this position, it is blocked from rotating in a direction that is clockwise in FIG. 14D and latch 518A cannot be pushed out of the way by forward edge 1452, even if a user pulls on flat flexible circuit 150 attempting to remove it, latching flat flexible circuit 150 in the connector.

In this example, arm 1430 has a projection 1450 that, in some states, is rotated into latching region 1460. But, rather than latching flat flexible circuit 150 in the connector, it is sized and shaped to automatically move the actuator to a closed state as flat flexible circuit 150 is withdrawn, if actuator was in a stable unlatched position. Projection 1450 is positioned to extending into latching region 1460 when the actuator is in the stable unlatched position. In this position, it may engage a portion of flat flexible circuit 150 as it is withdrawn. In this example, projection 1450 is aligned with latch 518A in an insertion direction (i.e. a direction in which flat flexible circuit 150 is moved to insert it into slot 114). Other aspects of the connector illustrated in FIGS. 14A-14D may be as elsewhere described herein in connection with any of the other embodiments. Latch 518A, for example, may engage a notch 154 of a flat flexible circuit when fully inserted in the connector.

Further, as shown in FIG. 14A, the actuator may be rotated into an unlatched position in which latch 518A has rotated out of notch 154, such that flat flexible circuit 150 may be withdrawn from the connector. FIG. 14A shows a user applying a force on beam 520 to rotate the actuator as described above, such as in connection with FIG. 10B.

In this example, the connector includes a stable, unlatched state position such as is discussed above in connection with FIGS. 13B and 13C. Accordingly, even after the user releases beam 520, the actuator stays in the unlatched position as illustrated in FIG. 14B and flat flexible circuit 150 may be withdrawn, as illustrated in FIG. 14C.

As flat flexible circuit 150 is withdrawn, it may interact with the actuator, moving the actuator from the stable state. Interaction, for example, may result from contact with projection 1450. In this example, projection 1450 extends into notch 154 when the actuator is in the stable, unlatched state of FIG. 14B. As flat flexible circuit 150 is withdrawn, the forward edge 1452 of notch 154 contacts projection 1450 as shown in FIG. 14C. As flat flexible circuit 150 is withdrawn past that point of contact, force transferred from the flat flexible circuit 150 to the actuator at that contact point rotates beam 520 towards its latched state.

Once the actuator has rotated sufficiently that it is out of its stable, unlatched state, it may continue to rotate into its latched position, as shown in FIG. 14D. In this example, the actuator is biased towards its latched state and the biasing force provides a force that drives the actuator to its latched state. Such a biasing force, for example, may be provided by a spring arm of a locking terminal, as described above, for example.

The auto-close function of the connector from a stable, unlatched state as illustrated in FIG. 14B-14C results from projection 1450 extending into latching region 1460 where it interferes with flat flexible circuit 150 being withdrawn while the actuator is in a position that it may rotate in a clockwise direction such that the actuator, once moved out of its stable unlatched state, projection 1450 rotates out of the latching region 1460, allowing flat flexible circuit 150 to be freely withdrawn. Accordingly, as a user applies a force on beam 520 to rotate the actuator (as shown in FIG. 14A) into a stable unlatched state (shown in FIG. 14B and 14C), latch 518A rotates out of the latching region and projection 1450 rotates to extend into the latching region, and flat flexible circuit 150 may be withdrawn from the connector. As flat flexible circuit 150 is withdrawn past the point of contact between projection 1450 and the forward edge 1452 of notch 154, force transferred from the flat flexible circuit 150 to the actuator at that contact point rotates beam 520 towards its latched state, where projection 1450 rotates out of the latching region and latch 518A rotates into the latching region as illustrated in FIG. 14D.

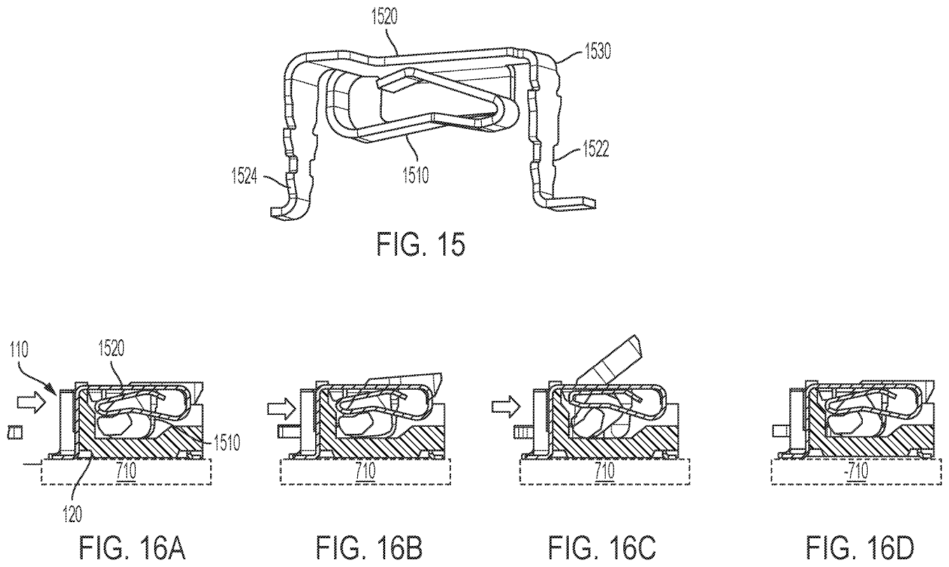

FIG. 15 depicts an alternative embodiment of a locking member that optionally may be used to provide for a more robust connector, particularly for a miniaturized connector that has a very low height, such as less than 10 mm, or less than 5 mm or less than 4 mm, in some examples. the inventors theorize that, to reliably generate enough force to move the actuator from an unlatched position to a latched position, the spring portion of the locking terminals may be preloaded such that they apply a force to a portion of the actuator even when the actuator is in a latched state. The inventors have recognized and appreciated that lessening the preload force may yield a more reliable connector. For example, during soldering the connector to a PCB, such as using a reflow process, the housing material may soften as a result of the heat used for soldering. The locking terminals may shift in the housing because of the preload force and may then be loose in operation, leading to errors in operation or accelerated failure of the connector. Nonetheless, the preload force, even if lessened, desirably should be sufficient to reliably move the actuator from an unlatched position to a latched position.

FIG. 15 depicts a front, left side, perspective view from below of a locking member, which may be used in a connector as described herein, such as in the exemplary board connector of FIG. 1. The locking member 1530 of FIG. 15 is similar to the locking member 130A depicted in FIGS. 6A-6C in structure and function, except that locking member 1530 has a differently shaped spring arm 1510.

Spring arm 1510 in this example has a double beam configuration having a first portion and a second portion. The first portion may contact the actuator, near its distal end, in the same way as beam 610 (FIG. 6A-6C). The second portion may extend from the first portion and contact another portion of the locking member, such as support arm 1520 near its distal end. Both portions may cooperate to provide a force on the actuator urging it towards a locked position.

In the example illustrated, the spring arm extends from support arm 1520 of locking terminal 1510 via the first portion at a first end of locking member 1510 and extends along a length of locking terminal 1510 to a second end. The second portion of spring arm 1510 may connect to the first portion at the second end of locking terminal 1510 and may extend back towards the first end of locking terminal 1510. Further, the second portion of spring arm 1510 may be configured to remain in contact with support arm 1520 when the actuator of the board connector is in a latched position. The spring arm 1510 may nonetheless be configured to provide a low preload force to the actuator when the actuator is in a latched position. For example, there may be a relatively small difference between the position of the spring arm when it is in its free state, as shown in FIG. 15 and when in the locked state as shown in FIG. 16A.

FIGS. 16A-16D are cross-sectional views through a spring arm of an exemplary board connector, such as the board connector of FIG. 1, having the locking member of FIG. 15 during insertion of a flexible circuit at successive steps in the insertion process. FIGS. 16A-16D illustrate the same steps in the insertion operation of FIGS. 7A-7D but illustrate connector 110 in a cross section through locking member 1510. As depicted in FIGS. 16A and 16D, when actuator 120 is in a latched position, actuator 120 and the first portion of spring arm 1510 may be in contact with each other and spring arm 1510 may apply a preload force. The second portion of spring arm 1510 may further be in contact with support arm 1520 when actuator 120 is in a latched position.

Other alterations, modifications, and improvements may be made to the structures, configurations, and methods discussed above, and are intended to be within the spirit and scope of the invention disclosed herein. Further, although advantages of the present invention are indicated, it should be appreciated that not every embodiment of the invention will include every described advantage. Some embodiments may not implement any features described as advantageous herein. Accordingly, the foregoing description and attached drawings are by way of example only.

Some aspects of the present technology may be embodied as one or more methods, and acts performed as part of a method of the present technology may be ordered in any suitable way. Accordingly, embodiments may be constructed in which acts are performed in an order different than shown and/or described, which may include performing some acts simultaneously, even though shown and/or described as sequential acts in various embodiments.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

As an example of other possible variations, a “user” of the connector was described. The user may be a human user or may be a robotic user.

Also, certain components were described as having multiple elements. In other examples, those elements may be implemented on different components. For example, rocker 516 is described as having surfaces 540A and 542A for limiting motion of actuator 120. Such limiting surfaces may be implemented on different components and/or may be on a portion of the projection from the arm of actuator 120 without an arcuate surface.

As another example, locking terminals were described as having both a support arm integrated into a U-shaped structure to capture a portion of the actuator and a spring arm to bias the actuator. These elements could be implemented as separate components. Likewise, tab 626 was illustrated as integral with support arm 620. In other examples, tab 626 or other component to capture hub 122A within an opening in housing 112 may be separate from locking terminal.

As an example of another variation, connector 110 was described as symmetrical, such that components at one end are repeated at the other end. It is not a requirement that a connector using techniques as described herein be symmetrical. Some or all of the components at one end of the connector may be omitted at the other. For example, limiting surfaces such as 540A and 542A may be present at only one end of the connector.

Use of ordinal terms such as “first,” “second,” “third,” etc., in the description and the claims to modify an element does not by itself connote any priority, precedence, or order of one element over another, or the temporal order in which acts of a method are performed, but are used merely as labels to distinguish one element or act having a certain name from another element or act having a same name (but for use of the ordinal term) to distinguish the elements or acts.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

As used herein in the specification and in the claims, the phrase “equal” or “the same” in reference to two values (e.g., distances, widths, etc.) means that two values are the same within manufacturing tolerances. Thus, two values being equal, or the same, may mean that the two values are different from one another by ±5%.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

Also, the phraseology and terminology used herein is for the purpose of description and should not be regarded as limiting. Use of terms such as “including,” “comprising,” “comprised of,” “having,” “containing,” and “involving,” and variations thereof herein, is meant to encompass the items listed thereafter and equivalents thereof as well as additional items.

The terms “approximately” and “about” if used herein may be construed to mean within ±20% of a target value in some embodiments, within ±10 % of a target value in some embodiments, within ±5% of a target value in some embodiments, and within ±2% of a target value in some embodiments. The terms “approximately” and “about” may equal the target value.

The term “substantially” if used herein may be construed to mean within 95% of a target value in some embodiments, within 98% of a target value in some embodiments, within 99% of a target value in some embodiments, and within 99.5% of a target value in some embodiments. In some embodiments, the term “substantially” may equal 100% of the target value.

### EXAMPLES

As an example, the invention may be embodied as an electrical connector comprising a housing configured to receive a mating component and comprising a mounting face; a plurality of contacts held in the housing; an actuator, wherein the actuator comprises a latching member configured to engage a mating component inserted into the housing; and an outer surface defining a shelf; is partially exposed outside of the housing; and is movably coupled to the housing so as to be movable between a latched position and an unlatched position; a locking terminal mounted to the housing, the locking terminal comprising a spring arm configured to press against the shelf when the actuator is moved from the latched position to the unlatched position so as to bias the actuator towards the latched position; and a support arm, wherein the spring arm is between the support arm and the shelf.

Optionally, such an electrical connector may include one or more of the following:

The spring arm and the support arm are integrally formed from a sheet of metal; and at least a portion of the support arm is wider than the spring arm.

The spring arm comprises a first portion and a second portion; the spring arm is configured such that the first portion presses against the shelf; and the spring arm is configured such that the second portion presses against the support arm when the actuator is moved from the latched position to the unlatched position.

The second portion of the spring arm is connected to the first portion of the spring arm at a distal end of the first portion and extends along at least a portion of the length of the first portion.

The latched position and the unlatched positions are stable states.

The tails of the plurality of contacts are soldered to the printed circuit board; the locking terminal is soldered to the printed circuit board at a first location and a second location; and the shelf is between the first location and the second location.

The actuator comprises a beam elongated in a first direction and comprising a first end and a second end; and an arm extending transversely to the first direction from the beam at the first end.

The housing comprises a cavity; and the arm comprises a distal end disposed within the cavity.

The distal end of the arm further comprises a hub; the housing comprises a notch bounded by a surface; and the actuator is disposed such that the hub bears against the surface of the notch when the actuator moves between the latched position and the unlatched position.

The cavity comprises a floor with an opening; and the latching member is positioned to extend through the opening when the actuator is in the latched position.

The latching member is disposed at the distal end of the arm.

The distal end of the arm further comprises a first portion comprising an arcuate surface; and the first portion is configured to rock along the floor of the cavity as the actuator moves from the latched to the unlatched position.

The shelf is an exterior surface of the first portion.

The arm is a first arm; the actuator further comprises a second arm extending transversely to the first direction from the beam at the second end; the cavity is a first cavity; the housing further comprises a second cavity; the second arm comprises a distal end disposed within the second cavity; the latching member is a first latching member and the actuator has a second latching member disposed at the distal end of the second arm; the locking terminal is a first locking terminal and the spring arm is a first spring arm; the electrical connector comprises a second locking terminal comprising a second spring arm; the shelf is a first shelf; the actuator further comprises a second shelf on an exterior surface of the distal end of the second arm; and the second spring arm is configured to press against the second shelf when the actuator is moved from the latched position to the unlatched position so as to bias the actuator towards the latched position.

The actuator further comprising a projection at the distal end of the first arm; and the shelf is formed on a portion of the projection.

The shelf is a first flat surface of the portion of the projection; and the portion of the projection comprises a second flat surface and a third flat surface.

The second flat surface and the third flat surface are transverse to the first flat surface; and the second flat surface is parallel to the third flat surface.

As an example, the invention may be embodied as an electrical connector comprising a housing comprising: a slot configured to receive a mating component; and a mounting face; a plurality of contacts held in the housing, wherein the plurality of contacts comprise tails, configured for mounting to a printed circuit board, exposed at the mounting face; an actuator, wherein the actuator: comprises a latching member configured to engage a mating component inserted into the housing; is partially exposed outside of the housing; and is movably coupled to the housing so as to be movable between a latched position and an unlatched position; a locking terminal mounted to the housing, the locking terminal comprising: a spring arm configured to press against a portion of the actuator when the actuator is moved from the latched position to the unlatched position so as to bias the actuator towards the latched position; and a support arm comprising a first end and a second end; a first member extending from the first end of the support arm to the mounting face and configured for mounting to the printed circuit board; and a second member extending from the second end of the support arm to the mounting face and configured for mounting to the printed circuit board.

Optionally, such an electrical connector may include one or more of the following:

The latched position and the unlatched positions are stable states.

The spring arm comprises a first portion and a second portion; the spring arm is configured such that the first portion presses against the shelf; and the spring arm is configured such that the second portion presses against the support arm when the actuator is moved from the latched position to the unlatched position.

The second portion of the spring arm is connected to the first portion of the spring arm at a distal end of the first portion and extends along at least a portion of the length of the first portion.

The housing comprises a cavity comprising an opening; the actuator comprises a beam and an arm extending from the beam; the actuator comprises a projection from a distal end of the arm; the projection is disposed, at least in part, within the cavity; and the support arm is disposed within the opening of the cavity.

The housing comprises an opening; and the projection of the actuator comprises a hub extending into the opening such that the actuator is movably coupled to the housing through engagement of the hub with the opening.

The locking terminal comprises a tab extending from and transverse to the support arm; and the tab captures the hub within the opening of the housing.

The cavity comprises a floor; and at least a portion of the projection comprises an arcuate surface adjacent to the floor.

The support arm is positioned to interfere with the at least a portion of the projection of the actuator so as to block further motion of the actuator when the actuator is moved to the unlatched position.

In combination with the printed circuit board, the tails of the plurality of contacts are soldered to the printed circuit board; the locking terminal comprises a base, with the locking arm extending from the base; and the base is soldered to the printed circuit board.

As an example, the invention may be embodied as a method of operating an electrical connector comprising a locking terminal comprising a spring arm and a support arm and an actuator comprising a latching member, the method comprising: biasing the actuator towards a latched position with the spring arm; and moving the actuator towards an unlatched position where a portion of the actuator abuts the support arm of locking terminal.

Optionally, such a method may include one or more of the following:

The actuator comprises a first portion disposed within a cavity of the housing and that has an arcuate surface; and moving the actuator comprises rocking the actuator by contacting successive regions of the arcuate surface to a floor of the cavity.

The first portion is constrained within the cavity by the support arm as the actuator rocks such that the actuator has a rotational component to its movement.

The actuator comprises a hub engaged in an opening of the housing; and moving the actuator comprises rotating the actuator about the hub.

The method further comprises inserting a flat flexible circuit into the slot while the actuator is biased into the latched position, such that an edge of the flat flexible circuit presses against the actuator so as to move the actuator towards the unlatched position; and the flat flexible circuit comprises a notch, offset from the edge, that receives the latching member, and the method further comprises moving the actuator towards the latched position such that the actuator moves into the latched position with the latching member disposed in the notch of the flat flexible circuit.

The actuator comprises a beam, an arm extending from the beam and a projection extending from a distal end of the arm, the projection comprising the hub; the method further comprises limiting rotation of the actuator by butting a surface of the projection against a surface of the housing.

The housing comprises a mounting face; the electrical connector further comprises a plurality of contacts held in the housing, wherein the plurality of contacts comprise tails exposed at the mounting face and mounted to a printed circuit board; the locking terminal comprises a first member extending from a first end of the support arm towards the mounting face and a second member extending from a second end of the support arm towards the mounting face; and the first member and the second member are configured for mounting to the printed circuit board at the mounting face.

As an example, the invention may be embodied as an electrical connector comprising a housing configured to receive a mating component and comprising a latching region; a plurality of contacts held in the housing; an actuator, wherein the actuator: comprises a latching member and a projection configured to engage a mating component inserted into the housing; is partially exposed outside of the housing; and is movably coupled to the housing so as to be movable between a latched position and an unlatched position, wherein: the latching member extends into the latching region and the projection extends outside the latching region when the actuator is in a latched position; and the latching member extends outside the latching region and the projection extends into the latching region when the actuator is in an unlatched position.

As an example, the invention may be embodied as a method of operating an electrical connector comprising: moving an actuator of the connector into a stable unlatched position in which a latch of the actuator is disengaged from mating component inserted in the connector; and withdrawing the mating component and urging the actuator out of the stable unlatched position as a result of interference between a projection of the actuator and the mating component such that a spring force rotates the actuator towards a stable latched position.

1. An electrical connector comprising:
a housing configured to receive a mating component and comprising a mounting face;
a plurality of contacts held in the housing;
an actuator, wherein the actuator:
comprises:
a latching member configured to engage a mating component inserted into the housing; and
an outer surface defining a shelf;
is partially exposed outside of the housing; and
is movably coupled to the housing so as to be movable between a latched position and an unlatched position;
a locking terminal mounted to the housing, the locking terminal comprising:
a spring arm configured to press against the shelf when the actuator is moved from the latched position to the unlatched position so as to bias the actuator towards the latched position; and
a support arm, wherein the spring arm is between the support arm and the shelf.

2. The electrical connector of claim 1, wherein:
the spring arm and the support arm are integrally formed from a sheet of metal; and
at least a portion of the support arm is wider than the spring arm.

3. The electrical connector of claim 1, wherein:
the spring arm comprises a first portion and a second portion;
the spring arm is configured such that the first portion presses against the shelf; and
the spring arm is configured such that the second portion presses against the support arm when the actuator is moved from the latched position to the unlatched position.

4. The electrical connector of claim 3, wherein:
the second portion of the spring arm is connected to the first portion of the spring arm at a distal end of the first portion and extends along at least a portion of a length of the first portion.

5. The electrical connector of claim 1, wherein:
the latched position and the unlatched position are stable states.

6. An electronic assembly comprising a connector as in claim 1 in combination with a printed circuit board, wherein:
tails of the plurality of contacts are soldered to the printed circuit board;
the locking terminal is soldered to the printed circuit board at a first location and a second location; and
the shelf is between the first location and the second location.

7. The electrical connector of claim 1, wherein:
the actuator comprises:
a beam elongated in a first direction and comprising a first end and a second end; and
an arm extending transversely to the first direction from the beam at the first end.

8. The electrical connector of claim 7, wherein:
the housing comprises a cavity; and
the arm comprises a distal end disposed within the cavity.

9. The electrical connector of claim 8, wherein:
the distal end of the arm further comprises a hub;
the support arm is positioned to interfere with at least a
portion of the hub of the actuator so as to block further motion of the actuator when the actuator is moved to the unlatched position.

10. The electrical connector of claim 8, wherein:
the cavity comprises a floor with an opening; and
the latching member is positioned to extend through the opening when the actuator is in the latched position.

11. The electrical connector of claim 10, wherein:
the latching member is disposed at the distal end of the arm.

12. The electrical connector of claim 11, wherein:
the distal end of the arm further comprises a first portion comprising an arcuate surface; and
the first portion is configured to rock along the floor of the cavity as the actuator moves from the latched to the unlatched position.

13. The electrical connector of claim 12, wherein:
the latching member is configured to engage with the mating component inserted into the housing so that the actuator is moved from the unlatched position to the latched position when the mating component is removed from the housing.

14. The electrical connector of claim 13, wherein:
the arm is a first arm;
the actuator further comprises a second arm extending transversely to the first direction from the beam at the second end;
the cavity is a first cavity;
the housing further comprises a second cavity;
the second arm comprises a distal end disposed within the second cavity;
the latching member is a first latching member and the actuator has a second latching member disposed at the distal end of the second arm;
the locking terminal is a first locking terminal and the spring arm is a first spring arm;
the electrical connector comprises a second locking terminal comprising a second spring arm;
the shelf is a first shelf;
the actuator further comprises a second shelf on an exterior surface of the distal end of the second arm; and
the second spring arm is configured to press against the second shelf when the actuator is moved from the latched position to the unlatched position so as to bias the actuator towards the latched position.

15. The electrical connector of claim 11, wherein:
the actuator further comprising a projection at the distal end of the first arm; and
the shelf is formed on a portion of the projection.

16. The electrical connector of claim 15, wherein:
the shelf is a first flat surface of the portion of the projection; and
the portion of the projection comprises a second flat surface and a third flat surface.

17. The electrical connector of claim 16, wherein:
the second flat surface and the third flat surface are transverse to the first flat surface; and
the second flat surface is parallel to the third flat surface.

18. An electrical connector comprising:
a housing comprising:
a slot configured to receive a mating component; and
a mounting face;
a plurality of contacts held in the housing, wherein the plurality of contacts comprise tails, configured for mounting to a printed circuit board, exposed at the mounting face;
an actuator, wherein the actuator:
comprises a latching member configured to engage a mating component inserted into the housing;
is partially exposed outside of the housing; and
is movably coupled to the housing so as to be movable between a latched position and an unlatched position;
a locking terminal mounted to the housing, the locking terminal comprising:
a spring arm configured to press against a portion of the actuator when the actuator is moved from the latched position to the unlatched position so as to bias the actuator towards the latched position; and
a support arm comprising a first end and a second end;
a first member extending from the first end of the support arm to the mounting face and configured for mounting to the printed circuit board in a first region of the printed circuit board; and
a second member extending from the second end of the support arm to the mounting face and configured for mounting to the printed circuit board in a second region of the printed circuit board.

19. The electrical connector of claim 18, wherein:
the latched position and the unlatched positions are stable states.

20. The electrical connector of claim 18, wherein:
the spring arm comprises a first portion and a second portion;
the spring arm is configured such that the first portion presses against a shelf; and
the spring arm is configured such that the second portion presses against the support arm when the actuator is moved from the latched position to the unlatched position.

21. The electrical connector of claim 20, wherein:
the second portion of the spring arm is connected to the first portion of the spring arm at a distal end of the first portion and extends along at least a portion of a length of the first portion.

22. The electrical connector of claim 18, wherein:
the housing comprises a cavity comprising an opening;
the actuator comprises a beam and an arm extending from the beam;
the actuator comprises a projection from a distal end of the arm;
the projection is disposed, at least in part, within the cavity; and
the support arm is disposed within the opening of the cavity.

23. The electrical connector of claim 22, wherein:
the housing comprises an opening; and
the projection of the actuator comprises a hub extending into the opening such that the actuator is movably coupled to the housing through engagement of the hub with the opening.

24. The electrical connector of claim 23, wherein:
the locking terminal comprises a tab extending from and transverse to the support arm; and
the tab captures the hub within the opening of the housing.

25. The electrical connector of claim 23, wherein:
the cavity comprises a floor; and at least a portion of the projection comprises an arcuate surface adjacent to the floor.

26. The electrical connector of claim 18, wherein:
the support arm is positioned to interfere with the at least a portion of a projection of the actuator so as to block further motion of the actuator when the actuator is moved to the unlatched position.

27. An electronic assembly comprising a connector as in claim 18 in combination with the printed circuit board, wherein:
the tails of the plurality of contacts are soldered to the printed circuit board;
the locking terminal comprises a base, with the locking arm extending from the base; and
the base is soldered to the printed circuit board.

28-36. (canceled)
